(19) United States
(12) Patent Application Publication
(10) Pub. No.: US 2013/0230385 A1
(43) Pub. Date: Sep. 5, 2013

(54) TURBINE PISTON

(71) Applicant: SCHAEFFLER TECHNOLOGIES AG & CO. KG, Herzogenaurach (DE)

(72) Inventors: Patrick Lindemann, Wooster, OH (US); Markus Steinberger, Macedonia, OH (US)

(73) Assignee: SCHAEFFLER TECHNOLOGIES AG & CO. KG, Herzogenaurach (DE)

(21) Appl. No.: 13/775,783

(22) Filed: Feb. 25, 2013

Related U.S. Application Data
(60) Provisional application No. 61/605,733, filed on Mar. 1, 2012.

(51) Int. Cl. F16D 33/18

(52) U.S. Cl. CPC F16D 33/18
USPC 415/122.1; 192/3.28

(57) ABSTRACT

A torque converter includes an impeller with a plurality of impeller blades and a shell with a radial wall disposed radially outside of the blades. The converter also includes a cover fixed to the impeller shell to form a housing, and a turbine. The turbine includes a plurality of turbine blades and a shell with a radial wall disposed radially outside of the turbine blades. The turbine radial wall is arranged to frictionally engage the impeller shell radial wall. In some example embodiments, the turbine shell includes indented slots and the turbine blades include tabs disposed in the slots. In an example embodiment, the turbine blades are fixed to the turbine shell by brazing.

### FIELD

The invention relates generally to a torque converter, and more specifically to a torque converter with a turbine piston.

### BACKGROUND

Torque converter turbines incorporating lockup clutches are known. One example is shown in commonly-assigned U.S. Pat. No. 7,445,099.

### BRIEF SUMMARY

Example aspects broadly comprise a torque converter including an impeller with a plurality of impeller blades and a shell with a radial wall disposed radially outside of the blades. The converter also includes a cover fixed to the impeller shell to form a housing, and a turbine. The turbine includes a plurality of turbine blades and a shell with a radial wall disposed radially outside of the turbine blades. The turbine radial wall is arranged to frictionally engage the impeller shell radial wall. In some example embodiments, the turbine shell includes indented slots and the turbine blades include tabs disposed in the slots. In an example embodiment, the turbine blades are fixed to the turbine shell by brazing.

In an example embodiment, the impeller shell radial wall or the turbine shell radial wall includes a friction material ring for frictional engagement with the other of the impeller shell radial wall or the turbine shell radial wall. In an example embodiment, the torque converter includes a stator assembly and a release spring disposed between the turbine shell and the stator assembly to urge the turbine away from the impeller.

In an example embodiment, the torque converter includes a damper spring retainer fixed to the turbine shell and a damper spring disposed in the spring retainer. In an example embodiment, the torque converter includes a damper flange arranged for driving and sealing engagement with a transmission input shaft. The turbine shell is sealed to the damper flange. In some example embodiments, the damper flange includes a thrust plate axially disposed between the flange and the turbine shell for transferring a thrust load from the turbine shell to the cover. In an example embodiment, the thrust plate or the turbine shell has a friction material ring and the flange or the cover comprises a friction material ring. In an example embodiment, the thrust plate includes a tab drivingly engaged with the damper spring.

In some example embodiments, the torque converter includes a damper spring retainer arranged for driving engagement with a transmission input shaft and a damper spring disposed in the spring retainer. The turbine shell includes an axial tab engaged with the damper spring. In an example embodiment, the axial tab is radially aligned with the turbine shell radial wall. In an example embodiment, the torque converter includes a damper hub fixed to the spring retainer by compressive engagement. In an example embodiment, the torque converter includes a turbine shell bushing arranged for sealing engagement with a transmission input shaft.

Other example aspects broadly comprise a torque converter assembly including a torus portion and a lockup clutch. The torus portion includes an impeller, a turbine, and a stator. The lockup clutch is for connecting the impeller and the turbine. The clutch is axially aligned with the stator. In some example embodiments, the lockup clutch is disposed radially outside of the torus portion. In an example embodiment, the lockup clutch comprises respective impeller and turbine radial walls. In an example embodiment, the torque converter includes a damper with a damper spring radially aligned and axially offset from the lockup clutch.

### BRIEF DESCRIPTION OF THE DRAWINGS

The nature and mode of operation of the present invention will now be more fully described in the following detailed description taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a top half cross section view of a first embodiment of a torque converter with a turbine piston according to an example aspect;

FIG. 3 is a top half cross section view of a second embodiment of a torque converter with a turbine piston according to an example aspect;

FIG. 4 is a top half cross section view of a third embodiment of a torque converter with a turbine piston according to an example aspect;

FIG. 5 is a top half cross section view of a fourth embodiment of a torque converter with a turbine piston according to an example aspect.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

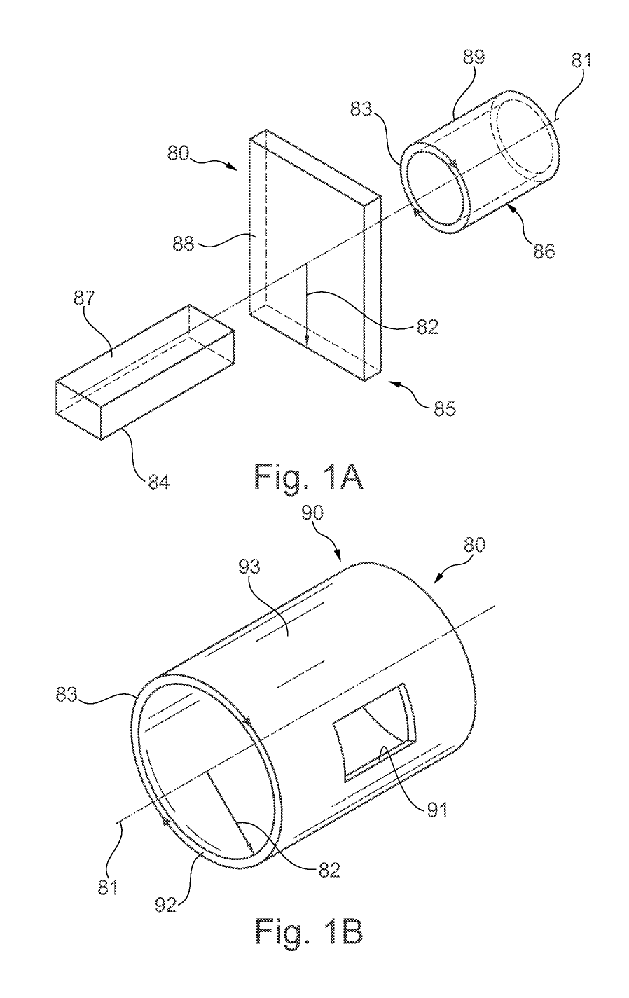

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

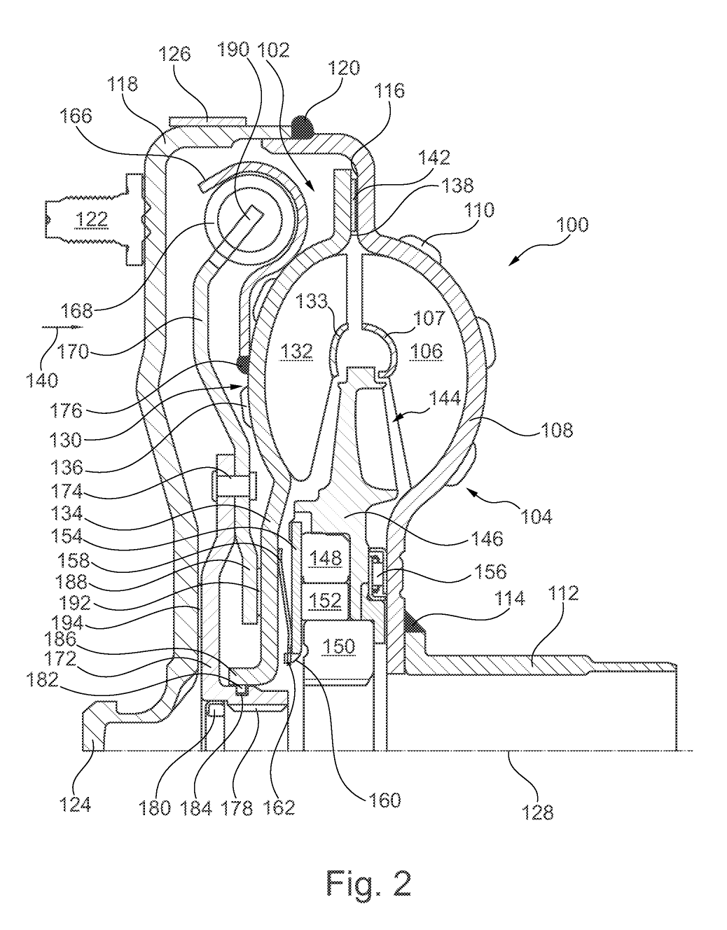

The following description is made with reference to FIG. 2. FIG. 2 is a top half cross section view of torque converter 100 with turbine piston 102. Converter 100 includes impeller 104 with a plurality of impeller blades 106, core ring 107, and shell 108. Blades 106 include tabs (not shown) installed in indented slots 110 of shell 108. Blades 106 are fixed to the shell by brazing as is known in the art. Impeller 104 includes hub 112 fixed to shell 108 by weld 114. Hub 112 is arranged for driving engagement with a hydraulic pump of a transmission (not shown).

Shell 108 includes radial wall 116 disposed radially outside of blades 106. Converter 100 includes cover 118 fixed to shell 108 at weld 120 to form a housing as is known in the art. Cover 118 includes stud 122 arranged for driving engagement with an engine flexplate (not shown) and pilot extrusion 124 arranged for centering converter 100 with regards to a crankshaft for the engine (not shown). Cover may include balance weight 126 for balancing converter 100 about axis 128.

Converter 100 includes turbine 130 with a plurality of turbine blades 132, core ring 133, and shell 134. Shell 134 is generally thicker than typical turbine shells to withstand pressure forces as described below. In an example embodiment, blades 132 include tabs (not shown) installed in indented slots 136 of shell 134. In an example embodiment, blades 132 are fixed to the shell by brazing. Shell 134 includes radial wall 138 disposed radially outside of blades 132. Wall 138 is arranged to frictionally engage wall 116. That is, upon application of a pressure force to shell 134 in direction 140, wall 138 is pressed against wall 116 so that torque received by shell 108 through cover 118 from the engine (not shown) is transmitted directly to turbine shell 134, bypassing the fluid circuit partially formed by blades 106 and 132. Walls 116 and 138 may be jointly referred to as a lockup clutch.

In an example embodiment, wall 138 includes friction material ring 142 for improved frictional performance. Ring 142 prevents metal-on-metal contact between walls 116 and 138, reducing contamination produced by the frictional engagement. Friction characteristics of ring 142 may further improve the engagement by increasing a friction coefficient between the clutch components or altering the friction coefficient gradient so that the clutch is more controllable and does not shudder. Although ring 142 is shown fixed to wall 138, other embodiments (not shown) may include ring 142 fixed to wall 116.

Converter 100 includes stator assembly 144 with housing 146, one way clutch outer race 148 press-fit into housing 146, inner race 150, and roller 152, and side plate 154. In an example embodiment, the lockup clutch is axially aligned with the stator assembly. Side plate 154 axially retains the one-way clutch components within housing 146. Thrust bearing 156 operates between housing 146 and shell 108. In an example embodiment, release spring 158 is disposed between turbine shell 134 and stator assembly 144, specifically side plate 154, to urge turbine 130 away from impeller 104. Release spring 158 may be a diaphragm spring, for example. Side plate 154 includes tab 160 and spring 158 includes tab 162 engaged with tab 160 for rotationally fixing the spring relative to the side plate.

Converter 100 includes damper assembly 164 with spring retainer 166, spring 168, drive plate 170, and flange 172. In an example embodiment, drive plate 170 is fixed to flange 172 by rivet 174. In an example embodiment, damper spring retainer 166 is fixed to turbine shell 134 by weld 176, for example, and damper spring 168 is disposed in the spring retainer. By disposed in, we mean the the spring retainer at least partially surrounds and retains the spring. In an example embodiment, the damper spring is radially aligned with the lockup clutch.

Damper flange 172 is arranged for driving and sealing engagement with a transmission input shaft at spline 178 and seal 180, for example. Turbine shell 134 is sealed to flange 172 at seal 182. That is, flange 172 includes groove 184 for receiving seal 182 and shell 134 includes cylindrical protrusion 186 engaged with the seal, effectively sealing the shell to the input shaft through seals 180 and 182, and flange 172.

In some embodiments, flange 172 includes thrust plate 188 axially disposed between the flange and the turbine shell for transferring a thrust load from the turbine shell to the cover. That is, thrust from turbine 130 is reacted by plate 188 to cover 118. Thrust plate 188 may be integral with drive plate 170 and includes tab 190 engaged with spring 168. In an example embodiment, the thrust plate includes friction material ring 192 and the flange includes friction material ring 194. The rings prevent steel-on-steel contact to reduce contamination as described for ring 142 above. Although rings 192 and 194 are shown fixed to the thrust plate and flange, respectively, ring 192 may be fixed to shell 134 and ring 194 may be fixed to cover 118.

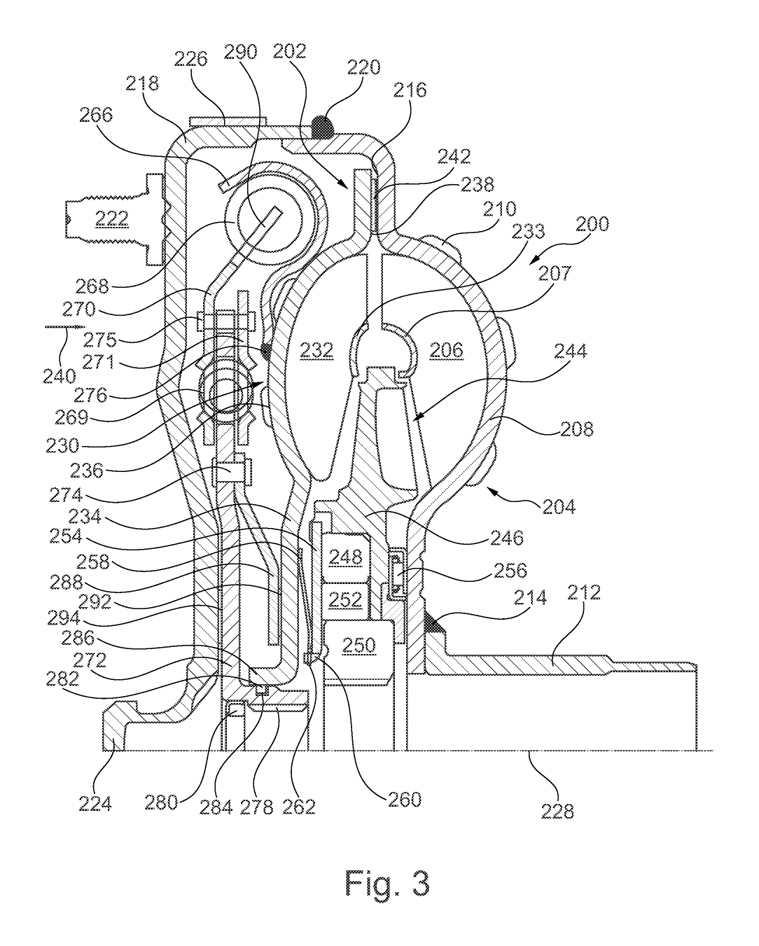

The following description is made with reference to FIG. 3. FIG. 3 is a top half cross section view of torque converter 200 with turbine piston 202. In general, the description of torque converter 100 above is applicable to torque converter 200 by replacing 1XX reference numerals with 2XX reference numerals considering the exceptions noted below. Flange 172 extends radially outward for driving engagement with spring 269. Drive plate 270 is engaged with spring 268 at tab 290 and fixed to cover plate 271 via rivet 275. Plates 270 and 271 are drivingly engaged with spring 269 so that torque from shell 234 is transmitted to flange 272 through retainer 266, spring 268, plates 270 and 271, and spring 269.

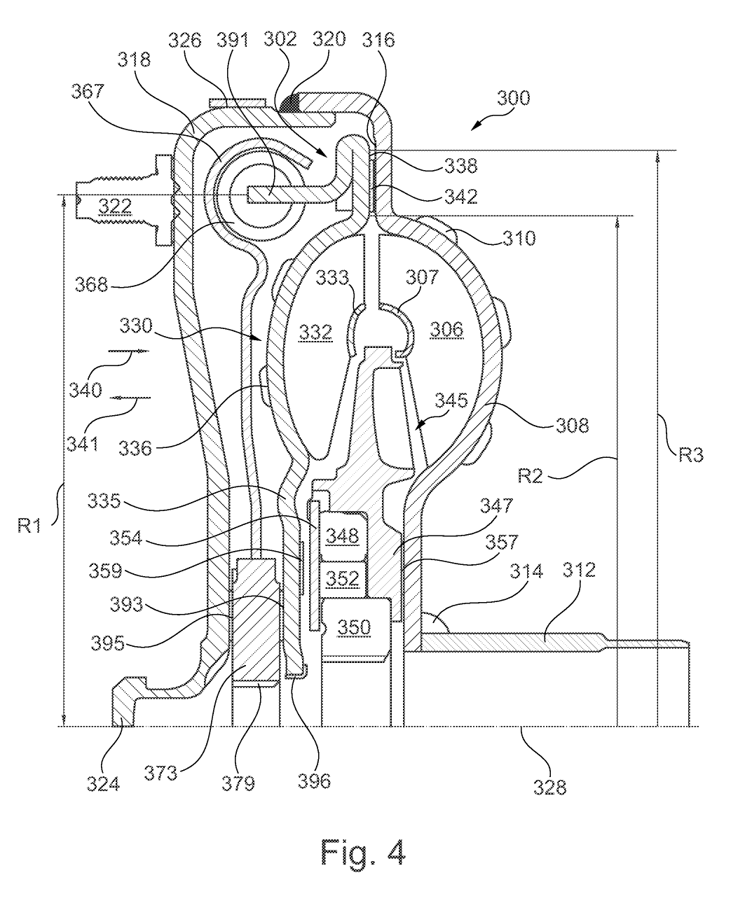

The following description is made with reference to FIG. 4. FIG. 4 is a top half cross section view of torque converter 300 with turbine piston 302. In general, the description of torque converter 100 above is applicable to torque converter 300 by replacing 1XX reference numerals with 2XX reference numerals considering the exceptions noted below. Torque converter 300 includes damper spring retainer 367 arranged for driving engagement with a transmission input shaft (not shown) and damper spring 368 disposed in the spring retainer. In an example embodiment, damper hub 373 is fixed to retainer 367 by compressive engagement. That is, hub 373 and retainer 367 are fixed together using the method described in commonly-assigned pending U.S. Provisional Patent Application No. 61/548,424, hereby incorporated by reference as if set forth fully herein.

Hub 373 includes spline 379 for driving engagement with the transmission input shaft and friction material rings 393 and 395. Together hub 373 and rings 393 and 395 provide a thrust path to the cover similar to flange 172, plate 188, and rings 192 and 194 in FIG. 2.

Spring 158 is replaced by friction material ring 359 so that shell 335 is released by a pressure force acting in direction 341, opposite direction 340, alone. Ring 359 prevents steel-on-steel contact between the shell and side plate 354 during a clutch engaged condition when shell 335 is urged in direction 340 or when stator 345 thrusts towards shell 335 in direction 341. In an example embodiment, bearing 156 is replaced by friction material ring 357 to prevent direct contact between aluminum stator housing 347 and steel impeller shell 108. Ring 357 may be fixed to shell 308 or housing 347, though it is likely easier to bond to the steel housing.

Turbine shell 335 includes axial tab 391 engaged with the damper spring. Tab 391 is radially aligned with radial wall 338. That is, radius R1 of tab 391 is between inner radius R2 and outer radius R3 of wall 338. Turbine shell 335 includes bushing 396 arranged for sealing engagement with the transmission input shaft. That is, instead of sealing through a flange as described in the example embodiments shown in FIGS. 2 and 3, shell 335 is directly sealed to the input shaft through bushing 396.

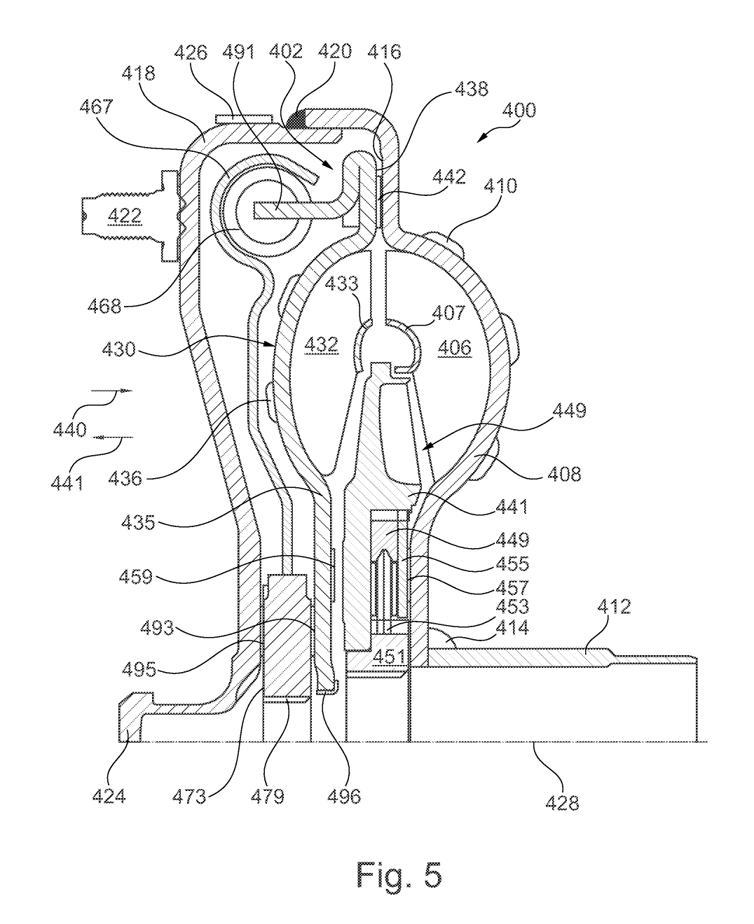

The following description is made with reference to FIG. 5. FIG. 5 is a top half cross section view of torque converter 400 with turbine piston 402. In general, the description of torque converter 300 above is applicable to torque converter 400 by replacing 3XX reference numerals with 4XX reference numerals considering the exceptions noted below. Converter 400 includes stator assembly 449 with housing 441, wedge one-way clutch outer race 449, inner race 451, and wedge plates 453, and side plate 455. Races 449 and 451 and plates 453 may be components of a friction one-way clutch as described in commonly-assigned U.S. Patent Application Publication No. 2009/0159390, hereby incorporated by reference as if set forth fully herein. Friction material ring 457 may be fixed to plate 455 or shell 408. Ring 459 prevents contact between shell 435 and housing 441 during a clutch engaged condition when shell 435 is urged in direction 440 or when stator 449 thrusts towards shell 435 in direction 441.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A torque converter comprising:
an impeller comprising:
a plurality of impeller blades, and;
a shell with a radial wall disposed radially outside of the blades a cover fixed to the impeller shell to form a housing; and, a turbine comprising:
a plurality of turbine blades, and;
a shell with a radial wall disposed radially outside of the turbine blades and arranged to frictionally engage the impeller shell radial wall.

2. The torque converter of claim 1 wherein the turbine shell includes indented slots and the turbine blades include tabs disposed in the slots.

3. The torque converter of claim 2 wherein the turbine blades are fixed to the turbine shell by brazing.

4. The torque converter of claim 1 wherein the impeller shell radial wall or the turbine shell radial wall includes a friction material ring for frictional engagement with the other of the impeller shell radial wall or the turbine shell radial wall.

5. The torque converter of claim 1 further comprising:
a stator assembly; and,
a release spring disposed between the turbine shell and the stator assembly to urge the turbine away from the impeller.

6. The torque converter of claim 1 further comprising a damper spring retainer fixed to the turbine shell and a damper spring disposed in the spring retainer.

7. The torque converter of claim 1 further comprising a damper flange arranged for driving and sealing engagement with a transmission input shaft, wherein the turbine shell is sealed to the damper flange.

8. The torque converter of claim 7 wherein the damper flange comprises a thrust plate axially disposed between the flange and the turbine shell for transferring a thrust load from the turbine shell to the cover.

9. The torque converter of claim 8 wherein the thrust plate or the turbine shell comprises a friction material ring and the flange or the cover comprises a friction material ring.

10. The torque converter of claim 8 wherein the thrust plate includes a tab drivingly engaged with the damper spring.

11. The torque converter of claim 1 further comprising a damper spring retainer arranged for driving engagement with a transmission input shaft and a damper spring disposed in the spring retainer, wherein the turbine shell includes an axial tab engaged with the damper spring.

12. The torque converter of claim 11 wherein the axial tab is radially aligned with the turbine shell radial wall.

13. The torque converter of claim 11 further comprising a damper hub fixed to the spring retainer by compressive engagement.

14. The torque converter of claim 1 further comprising a turbine shell bushing arranged for sealing engagement with a transmission input shaft.

15. A torque converter assembly comprising:
a torus portion including an impeller, a turbine, and a stator; and,
a lockup clutch for connecting the impeller and the turbine axially aligned with the stator.

16. The torque converter of claim 15 wherein the lockup clutch is disposed radially outside of the torus portion.

17. The torque converter of claim 16 wherein the lockup clutch comprises respective impeller and turbine radial walls.

18. The torque converter of claim 15 further comprising a damper with a damper spring radially aligned and axially offset from the lockup clutch.
